(19) United States
(12) Patent Application Publication
(10) Pub. No.: US 2016/0239260 A1
(43) Pub. Date: Aug. 18, 2016

(54) DISPLAY APPARATUS AND METHOD OF OPERATING SAME

(71) Applicant: SAMSUNG ELECTRONICS CO., LTD., Suwon-si (KR)

(72) Inventors: Duck-ki Yum, Suwon-si (KR); Hae-rim Son, Seoul (KR); Yui-yoon Lee, Suwon-si (KR); Jae-eun Cheon, Yangju-si (KR)

(73) Assignee: SAMSUNG ELECTRONICS CO., LTD., Suwon-si (KR)

(21) Appl. No.: 14/994,201

(22) Filed: Jan. 13, 2016

(30) Foreign Application Priority Data
Feb. 12, 2015 (KR) 10-2015-0021780

(51) Int. Cl. G06F 3/16; G06F 3/0484

(52) U.S. Cl. CPC G06F 3/167; G06F 3/04842

(57) ABSTRACT

A display apparatus includes a display; an audio output module; and a controller that controls the display to display objects selectable by a user on a screen of the display and controls the audio output module to output audio data corresponding to the displayed objects, in response to an input from a control device, during a mute activation state or a voice explanation off state of the display apparatus.

### CROSS-REFERENCE TO RELATED APPLICATION

This application claims priority from Korean Patent Application No. 10-2015-0021780, filed on Feb. 12, 2015, in the Korean Intellectual Property Office, the disclosure of which is incorporated by reference herein in its entirety.

### BACKGROUND

1. Field

The present disclosure relates to a display apparatus and a method of operating the same.

2. Description of the Related Art

Display apparatuses are apparatuses having a function of displaying an image so as to be viewed by a user. For example, a television (TV) apparatus as an example of a display apparatus used to only have a function of displaying a broadcast image by receiving a broadcast signal broadcast by a broadcasting station only in a unidirection in the past. However, a current TV apparatus has various functions of not only receiving a broadcast signal broadcast by a broadcasting station but also outputting various pieces of image content, controlling home appliances, and the like. As such, the significance of a TV apparatus in everyday life has been gradually increasing.

However, users having visual handicaps still suffer difficulty in the use of display apparatuses. Therefore, a display apparatus operating method for users having visual handicaps and a display apparatus therefor would be advantageous.

### SUMMARY

According to an aspect of an exemplary embodiment, a display apparatus includes: a display; an audio output module; and a controller configured to control the display to display objects selectable by a user on a screen of the display and control the audio output module to output audio data corresponding to the displayed objects, in response to an input from a control device, during a mute activation state or a voice explanation off state of the display apparatus.

The input from the control device may comprise a long-pressed input via a specific key provided on the control device.

The objects may include at least one of icons, texts, and images for executing at least one of a mute inactivation function, a screen magnification function, and a control device guide function.

The controller may control the audio output module to output audio data including information about at least one of a name of a first function corresponding to a first object and a feature of the first function, in response to an input, received via the control device, of selecting the first object from among the displayed objects.

The controller may execute the first function corresponding to the first object in response to an input, received via the control device, of executing the first function corresponding to the first object, and may control the audio output module to output audio data corresponding to information to be displayed on the screen of the display apparatus according to the execution of the first function.

According to another aspect of an exemplary embodiment, there is provided a display apparatus comprising a display; an audio output module; a user input module configured to receive an input of activating a control device guide function and to receive an input via a first key provided on the control device; and a controller configured to control the audio output module and the display to respectively output audio data corresponding to the first key and image data corresponding to the first key, in response to the input via the first key.

The controller may control the audio output module and the display not to perform an operation corresponding to the first key, according to the activation of the control device guide function.

The audio data corresponding to the first key may include information about at least one of a name of the first key and a function corresponding to the first key.

The image data corresponding to the first key may be a magnified image of an external appearance of the first key in an external appearance of the control device.

The input of activating the control device guide function may be a preset motion input.

The user input module may receive an input via an end key provided on the control device, and the controller may inactivate the control device guide function when the input via the end key is continuously received.

According to another aspect of an exemplary embodiment, there is provided a method of operating a display apparatus, the method comprising displaying objects selectable by a user on a screen of the display apparatus in response to an input from a control device, during a mute activation state or a voice explanation off state of the display apparatus; and outputting audio data corresponding to the displayed objects.

The input from the control device may comprise a long-pressed input via a specific key provided on the control device.

The objects may include at least one of icons, texts, and images for executing at least one of a mute inactivation function, a screen magnification function, and a control device guide function.

The outputting of the audio data corresponding to the displayed objects may comprise receiving an input, via the control device, of selecting a first object from among the displayed objects; and outputting audio data including information about at least one of a name of a first function corresponding to the first object and a feature of the first function, in response to the input via the control device.

The outputting of the audio data corresponding to the displayed objects may comprise receiving an input, via the control device, of executing the first function corresponding to the first object; and outputting audio data corresponding to information to be displayed on the screen of the display apparatus according to the execution of the first function, in response to the input via the control device.

According to another aspect of an exemplary embodiment, there is provided a method of operating a display apparatus, the method comprising activating a control device guide function; receiving an input via a first key provided on a control device; and outputting audio data corresponding to the first key and image data corresponding to the first key, in response to the input via the first key.

The receiving of the input via the first key provided on the control device may comprise not executing a function corresponding to the first key, according to the activation of the control device guide function.

The audio data corresponding to the first key may include information about at least one of a name of the first key and a function corresponding to the first key.

The image data corresponding to the first key may be a magnified image of an external appearance of the first key in an external appearance of the control device.

The input of activating the control device guide function may be a preset motion input.

The method may further comprise receiving an input via an end key provided on the control device; and inactivating the control device guide function if the input via the end key is continuously received.

According to another aspect of an exemplary embodiment, there is provided a non-transitory computer-readable medium having recorded thereon a computer-readable program for performing a method comprising displaying objects selectable by a user on a screen of the display apparatus in response to an input from a control device, during a mute activation state or a voice explanation off state of the display apparatus; and outputting audio data corresponding to the displayed objects.

According to another aspect of an exemplary embodiment, there is provided a display apparatus comprising an audio output module; and a controller configured to, in response to receiving a pre-defined input from a control device, override a mute function or a voice explanation off function of the display apparatus and output audio data corresponding to objects normally displayed on the display apparatus through the audio output module.

The pre-defined input may be set according to a user setting.

The pre-defined input may comprise a signal received by the display apparatus that indicates a key on the control device has been activated for a threshold period of time or more.

The pre-defined input may comprise a signal received by the display apparatus that indicates a key on the control device has been activated for a threshold number of times within a period of time.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 illustrates a display system according to an exemplary embodiment;

FIG. 2 illustrates a block diagram of a display apparatus in the display system of FIG. 1, according to an exemplary embodiment;

FIG. 3 illustrates a block diagram of a controller in the display apparatus of FIG. 2;

FIGS. 4A and 4B illustrate examples of a control device in the display system of FIG. 1;

FIG. 5 illustrates a flowchart of a method of operating the display apparatus, according to an exemplary embodiment;

FIG. 6 illustrates an example in which the display apparatus displays objects selectable by a user on a screen;

FIG. 7 illustrates a flowchart of a method by which the display apparatus outputs audio data corresponding to objects displayed on the screen, according to an exemplary embodiment;

FIG. 8 illustrates an example in which the display apparatus outputs audio data corresponding to a selected first object;

FIG. 9 illustrates a flowchart of a method by which the display apparatus outputs audio data according to the execution of a first function corresponding to the first object, according to an exemplary embodiment;

FIG. 10 illustrates a block diagram of a display apparatus according to another exemplary embodiment;

FIG. 11 illustrates an example in which the display apparatus provides a control device guide function;

FIG. 12 an example in which the display apparatus executes the control device guide function;

FIG. 13 illustrates an example of a key explanation table;

FIG. 14 illustrates an example in which the display apparatus displays, on the screen, a notification that a control device guide function is activated;

FIG. 15 illustrates a flowchart of a method of operating a display apparatus, according to another exemplary embodiment;

FIG. 16 illustrates a flowchart of a method by which the display apparatus executes the control device guide function, according to another exemplary embodiment;

FIG. 17 illustrates an example in which the display apparatus outputs audio data and image data in response to an input from a control device;

FIG. 18 illustrates another example in which the display apparatus outputs audio data and image data in response to an input from the control device; and

FIG. 19 illustrates a detailed block diagram of the display apparatus.

### DETAILED DESCRIPTION

The terms used in the specification will be briefly described, and then, the inventive concept will be described in detail.

The terms used in this specification are those general terms currently widely used in the art, but the terms may vary according to the intention of those of ordinary skill in the art, precedents, or new technology in the art. Also, specified terms may be selected by the applicant, and in this case, the detailed meaning thereof will be described in the detailed description. Thus, the terms used in the specification should be understood not as simple names but based on the meaning of the terms and the overall description.

Throughout the specification, when a component “includes” an element, unless there is another opposite description thereto, it should be understood that the component does not exclude another element but may further include another element. In addition, terms such as “ . . . unit”, “ . . . module”, or the like refer to units or modules that perform at least one function or operation, and the units may be implemented as hardware or software or as a combination of hardware and software.

In addition, in the specification, “content” may indicate information provided over a broadcast network, the Internet, or the like. The content may include, for example, video content (e.g., TV program content, a video on demand (VOD), user-created content (UCC), a music video, YouTube content, and the like), still image content (e.g., a photograph, a picture, and the like), text content (e.g., an e-book (poems and novels), a letter, and a business file), music content (e.g., music, instrumentals, a radio broadcast program, and the like), a webpage, application execution information, and the like but is not limited thereto.

In addition, in the specification, “user” indicates a person who controls a function or operation of a display apparatus by using a control device and may include an audience, a manager, or an installation engineer.

In addition, in the specification, “user input” may include a touch input, a voice input, a button input, or a user motion input via a device. Herein, the touch input may be caused by at least one gesture of a touch, a hold, a tap, a flick, a pinch, a touch & drag, and a touch & hold.

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. In the drawings, parts irrelevant to the description are omitted to clearly describe the inventive concept. Accordingly, the exemplary embodiments are merely described below, by referring to the figures, to explain aspects of the inventive concept.

As used herein, the term “and/or” includes any and all combinations of one or more of the associated listed items. Expressions such as “at least one of,” when preceding a list of elements, modify the entire list of elements and do not modify the individual elements of the list.

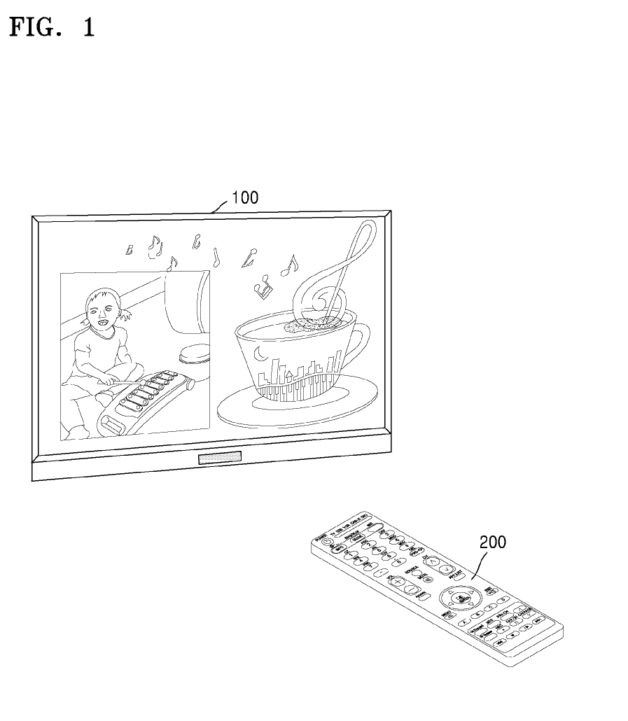

FIG. 1 illustrates a display system according to an exemplary embodiment. Referring to FIG. 1, the display system may include a display apparatus 100 and a control device 200.

The display apparatus 100 may output image content. The display apparatus 100 may receive the image content through a broadcasting station, a server connected over a network, an external device connected in a wired or wireless manner, a storage included in the display apparatus 100, or the like. The image content includes video data and may further include audio data. In addition, the display apparatus 100 may output a user interface (UI) for operating the display apparatus 100. For example, the UI may be an on screen display (OSD) menu, program information, an electronic program guide (EPG), an application icon, an application window, a UI window, a web browsing window, or the like but is not limited thereto.

The display apparatus 100 may be implemented by not only a flat display apparatus but also, a curved display apparatus including a screen having a curvature, or a flexible display apparatus whose curvature is adjustable. In addition, the display apparatus 100 is not only referred to as a display apparatus such as a TV but may be implemented by various other types of electronic devices connectable to the control device 200 through a short-distance communication network.

An output resolution of the display apparatus 100 may include, for example, high definition (HD), full HD, ultra HD, or a clearer resolution than ultra HD.

The control device 200 may transmit control information to the display apparatus 100 by various communication schemes. For example, the control device 200 may transmit control information to the display apparatus 100 by a communication scheme such as wireless local area network (LAN), Wi-Fi, Bluetooth, ZigBee, Wi-Fi Direct (WFD), ultra wideband (UWB), infrared data association (IrDA), Bluetooth low energy (BLE), near field communication (NFC), or the like.

The control device 200 may generate control information according to a user input received through at least one of a key, a microphone, and a sensor provided on the control device 200. The key may include a physical button or a touch button displayed on a touchpad of the control device 200. The key may include a plurality of keys. The microphone is configured to receive a voice of a user, and the sensor is configured to recognize a motion of the user. The microphone may include a plurality of microphones in order to provide stereo audio input. The sensor may include a plurality of sensors of similar or different types. In addition, the control information generated according to the user input may include information for variously controlling an output of the display apparatus 100, such as turning on/off power of the display apparatus 100, changing a channel, adjusting a volume, selecting a type of broadcasting such as terrestrial broadcast, cable broadcast, satellite broadcast, or the like, or setting an environment.

The control device 200 may be a TV remote control, a pointer, a mouse, a motion recognizer, or the like but is not limited thereto. For example, the control device 200 may be implemented by various electronic devices such as a smart device such as a smartphone or a tablet personal computer (PC), a portable electronic device, a wearable device, a home terminal connectable to a home network, and the like.

According to an exemplary embodiment, the display apparatus 100 may provide an interfacing method and device by which people having visual handicaps conveniently operate the display apparatus 100. According to an exemplary embodiment, the display apparatus 100 may output a shortcut menu window provided with a voice explanation if a pre-defined input is received from the control device 200, during a mute activation state or a voice explanation off state.

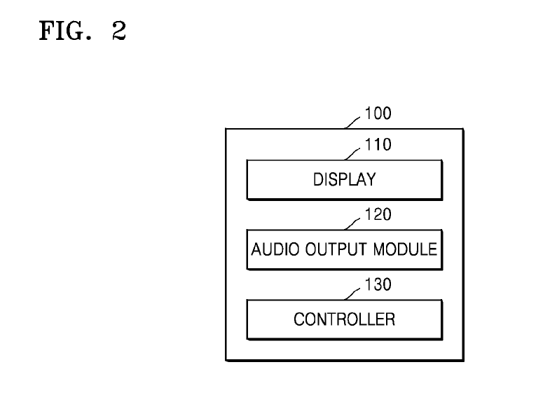

FIG. 2 illustrates a block diagram of the display apparatus 100 of FIG. 1, according to an exemplary embodiment.

Referring to FIG. 2, the display apparatus 100 may include a display 110, an audio output module 120, and a controller 130.

The display 110 may display, on a screen, video data included in image content (e.g., a TV program) acquired from a broadcast signal received from the outside. Alternatively, the display 110 may display video data included in image content (e.g., a video) streamed or downloaded from an external device or an external server. Alternatively, the display 110 may display video data of image content stored in a storage under control of the controller 130.

In addition, the display 110 may display a voice user interface (UI) for performing a voice recognition task corresponding to voice recognition or a motion UI for performing a motion recognition task corresponding to motion recognition.

The display 110 may be implemented using various displays, such as a liquid crystal display (LCD), a cathode ray tube (CRT) display, a plasma display panel (PDP) display, an organic light-emitting diode (OLED) display, a field emission display (FED), a light-emitting diode (LED) display, a vacuum fluorescence display (VFD), a digital light processing (DLP) display, a flat panel display (FPD), a three-dimensional (3D) display, a transparent display, and the like.

The audio output module 120 may process audio data included in image content under control of the controller 130. Alternatively, the audio output module 120 may process audio data for a voice explanation, such as a menu explanation, a menu execution, an application explanation, an application execution, or the like, under control of the controller 130.

The audio output module 120 may variously perform processing with respect to, for example, decoding, amplification, noise filtering, and the like.

The audio output module 120 may output audio data through a speaker included in the display apparatus 100 or an external speaker. The speaker may be implemented by a two-channel speaker, a 2.1-channel speaker, a four-channel speaker, a 4.1-channel speaker, a 5.1-channel speaker, a 6.1-channel speaker, a 7.1-channel speaker, a 9.1-channel speaker, or an 11.2-channel speaker, but it will be readily understood by those of ordinary skill in the art that the speaker is not limited thereto.

The controller 130 controls a general operation of the display apparatus 100 and a signal flow between the internal components of the display apparatus 100 and executes a function of processing data.

The controller 130 may control at least one of an optical signal output from the control device 200, an input via a panel key (not shown) provided on a main body of the display apparatus 100, a voice of the user, and a motion of the user to be received as a user input. The user input may be differently described as various terms such as a user operation, a user command, an input command, and the like.

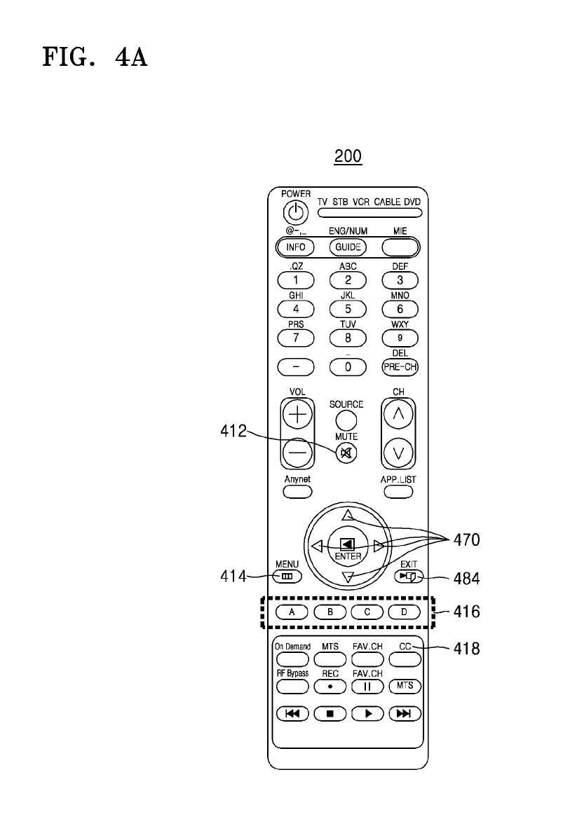

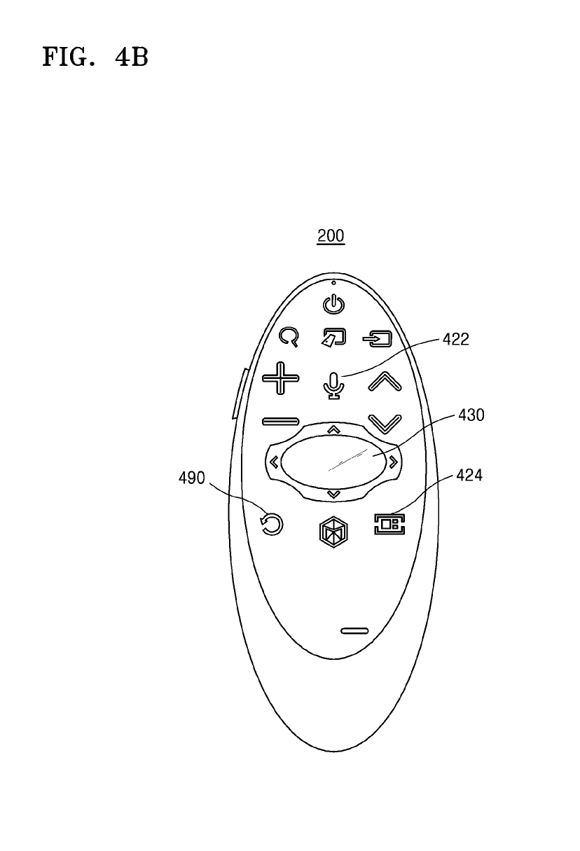

According to an exemplary embodiment, if a pre-defined input from the control device 200 is received, the controller 130 may control the display 110 to display objects selectable by the user on the screen. The pre-defined input from the control device 200 may be, for example, a long-pressed input via a specific key provided on the control device 200, as shown in FIGS. 4A and 4B.

In addition, the objects may include at least one of icons, texts, and images preset to execute some functions provided to users having visual handicaps from among functions executable in the display apparatus 100. For example, the controller 130 may control the display 110 to display, on the screen, objects through which a mute activation/inactivation function, a screen magnification function, a high contrast function, a control device guide function, and the like are executable.

The mute activation/inactivation function denotes a function for setting activation or inactivation of a mute function of the display apparatus 100. During the mute activation state, the controller 130 may control the audio output module 120 not to output audio data of image content being displayed on the screen.

The screen magnification function denotes a function for magnifying an image being displayed on the screen of the display apparatus 100 by a magnification ratio (e.g., 1.2 times, 1.5 times, double, or the like). The magnification ratio may be pre-defined, or may be set by a user as part of user settings. If the screen magnification function is activated, the controller 130 may generate image data interpolated based on original image data. The controller 130 may generate image data corresponding to a specific magnification ratio by using a scheme of, for example, zero-order interpolation, spline interpolation, linear interpolation, cubic convolution interpolation, or the like.

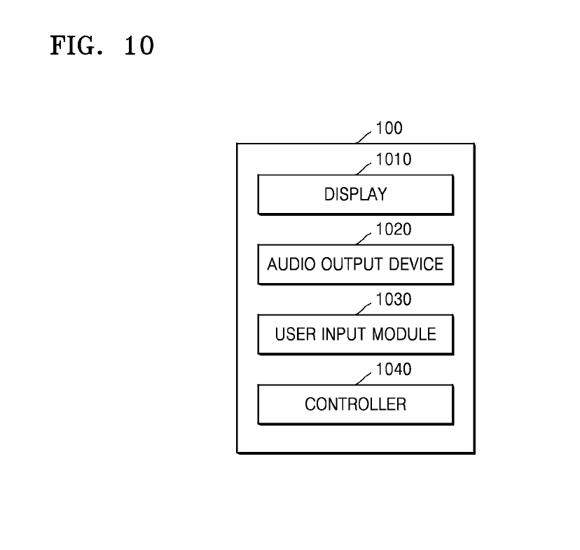

The control device guide function denotes a function for allowing the user to learn keys provided on the control device 200 (including physical buttons or touch buttons displayed on a touchpad). For example, if a user input (e.g., a key press or a key touch) of selecting one of keys provided on the control device 200 is received, the controller 130 may control the audio output module 120 to output audio data describing the selected key. A method by which the display apparatus 100 executes the control device guide function, according to an exemplary embodiment, will be described in detail below with reference to FIGS. 10 to 19.

Meanwhile, if a pre-defined input from the control device 200 is received, the controller 130 may further display objects through which a voice explanation on/off function, a focus magnification function, and the like are executable, and the displayed objects are not limited thereto. The pre-defined input may be, for example, pre-set by the manufacturer, or may be set by the user as a user setting option.

According to an exemplary embodiment, the controller 130 may control the audio output module 120 to output audio data corresponding to the displayed objects. According to an exemplary embodiment, the controller 130 may control the audio output module 120 to output the audio data corresponding to the displayed objects even during the mute activation state or the voice explanation off state. That is, the controller 130 may control the audio output module 120 to effectively override a mute or voice-explanation off state.

For example, if a pre-defined input from the control device 200 is received, the controller 130 may control the audio output module 120 to output both audio data included in image content being played and the audio data corresponding to the displayed objects. Alternatively, during the mute activation state or the voice explanation off state, the controller 130 may separate the audio data included in the image content being played and the audio data corresponding to the displayed objects and control the audio output module 120 to output only the audio data corresponding to the displayed objects.

According to an exemplary embodiment, if an input from the control device 200 of selecting a first object from among the displayed objects is received, the controller 130 may control the audio output module 120 to output audio data corresponding to the first object. For example, the controller 130 may control the audio output module 120 to output audio data describing a name (e.g., “mute function”) of a first function corresponding to the first object, a feature or state (e.g., “mute function is activated”) of the first function, or the like.

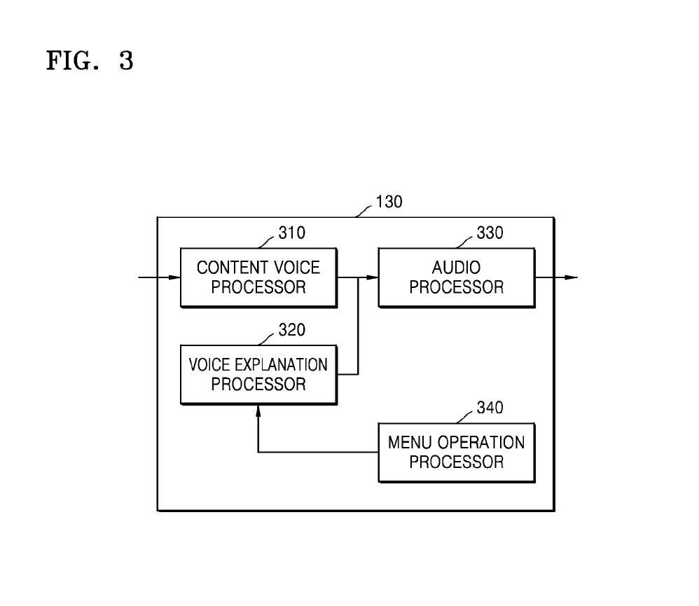

According to an exemplary embodiment, if an input from the control device 200 of executing the first function is received, the controller 130 may control the audio output module 120 to output audio data corresponding to information to be displayed on the screen according to the execution of the first function. A method by which the controller 130 transmits audio data to the audio output module 120 will be described in detail below with reference to FIG. 3.

As described above, according to an exemplary embodiment, the display apparatus 100 may provide objects through which functions useful to people having visual handicaps are executable, with a voice explanation in response to a pre-defined input from the control device 200 regardless of the mute activation state or a voice explanation on/off state.

FIG. 3 illustrates a block diagram of the controller 130 of FIG. 2.

Referring to FIG. 3, the controller 130 may include a content voice processor 310, a voice explanation processor 320, an audio processor 330, and a menu operation processor 340.

According to an exemplary embodiment, the content voice processor 310 may process audio data included in image content. For example, the content voice processor 310 may demodulate audio data included in a broadcast signal and demultiplex the demodulated audio data. In addition, the content voice processor 310 may transmit the demultiplexed audio data to the audio processor 330.

According to an exemplary embodiment, the voice explanation processor 320 may convert text data received from the menu operation processor 340 into audio data. For example, the voice explanation processor 320 may include a text-to-speech engine. The voice explanation processor 320 may transmit, to the audio processor 330, the audio data converted from the text data.

According to an exemplary embodiment, the menu operation processor 340 may process operations for various menus provided by the display apparatus 100. For example, the menu operation processor 340 may display various menu windows on the screen. In addition, in response to an input from the control device 200, the menu operation processor 340 may select one menu included in a menu window and display sub-menus included in the one menu on the screen or perform an operation corresponding to the one menu.

In addition, the menu operation processor 340 may acquire text data of explaining the menu window displayed on the screen. In addition, the menu operation processor 340 may acquire text data of explaining one menu included in the menu window in response to an input from the control device 200.

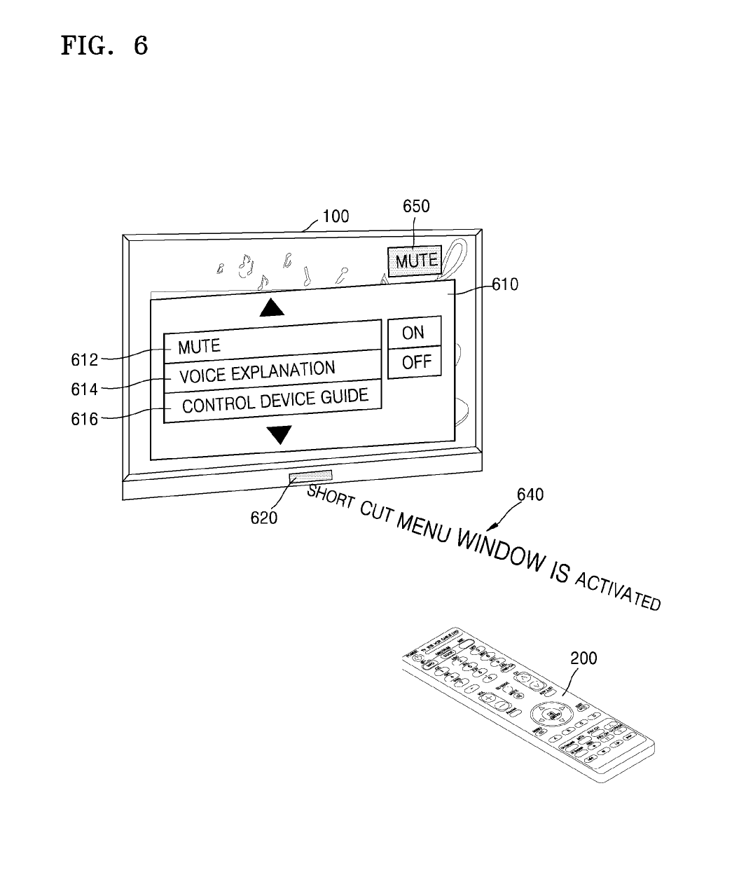

For example, if a pre-defined input from the control device 200 is received, the menu operation processor 340 may display, on the screen, a shortcut menu window including the objects described with reference to FIG. 6. The objects may be preset. For example, as shown in FIG. 6, the menu operation processor 340 may display a shortcut menu window on the screen by overlapping image content being played by the display apparatus 100. In addition, the menu operation processor 340 may acquire text data of explaining a shortcut menu window (e.g., “shortcut menu is activated” or the like) and text data of explaining one menu included in the shortcut menu window (e.g., “control device guide function starts” or the like).

In addition, the menu operation processor 340 may transmit the acquired text data to the voice explanation processor 320.

According to an exemplary embodiment, the audio processor 330 may receive audio data from the content voice processor 310 and the voice explanation processor 320 and transmit the received audio data to the audio output module 120.

In addition, the audio processor 330 may check whether the display apparatus 100 is in the mute activation state and/or whether the display apparatus 100 is in the voice explanation on state.

In the voice explanation off state, the audio processor 330 may transmit only the audio data received from the content voice processor 310 to the audio output module 120. In the mute activation state, regardless of whether the display apparatus 100 is in the voice explanation on state, the audio processor 330 may transmit no audio data to the outside.

However, according to an exemplary embodiment, if a pre-defined input from the control device 200 is received, the audio processor 330 may transmit both the audio data received from the content voice processor 310 and the audio data received from the voice explanation processor 320 to the audio output module 120 even in the voice explanation off state. Alternatively, the audio processor 330 may transmit the audio data received from the voice explanation processor 320 to the audio output module 120 even in the mute activation state.

With respect to the components included in the display apparatus 100 of FIGS. 2 and 3, at least one component may be added or omitted according to the performance of the display apparatus 100. In addition, it will be readily understood by those of ordinary skill in the art that locations of the components may be changed according to the performance or structure of the display apparatus 100.

FIGS. 4A and 4B illustrate examples of the control device 200 of FIG. 1.

Referring to FIG. 4A, according to an exemplary embodiment, the control device 200 may include function keys through which preset functions are executable, such as a mute activation/inactivation key 412, a menu key 414, a closed caption (CC) key 418, an audio description (AD) key (not shown), and the like, besides a channel up/down key and a volume up/down key. In addition, the control device 200 may include function keys through which additional functions according to a function being executed are selectable. The preset functions may be set in advance by the manufacturer, or may be predefined by the user and assigned to various ones of the keys.

According to an exemplary embodiment, the display apparatus 100 may measure a maintaining time of an input (e.g., a key press, a key touch, or the like) on the control device 200. In addition, the display apparatus 100 may control a function thereof according to the maintaining time of the input via the control device 200 (hereinafter, referred to as “input maintaining time”).

For example, if an input maintaining time of the mute activation/inactivation key 412 exceeds a threshold time (i.e., for a long-pressed input), the display apparatus 100 may display a shortcut menu window 610 including objects on the screen, as shown in FIG. 6, instead of activating (or inactivating) a mute function of the display apparatus 100. The objects may be preset. In this case, the objects may be icons, images, texts, and the like for executing the mute activation/inactivation function, the screen magnification function, the control device guide function, and the like as described above with reference to FIG. 2.

As another example, if an input maintaining time of the menu key 414 of the control device 200 exceeds the threshold time, the display apparatus 100 may display the shortcut menu window 610 of FIG. 6 instead of displaying an OSD menu on the screen.

Referring to FIG. 4B, according to another exemplary embodiment, the control device 200 may be a pointing device including function keys, such as a voice explanation on/off key 422, a menu key 424, and the like, and a touchpad 430. When the control device 200 is implemented by the pointing device, the display apparatus 100 may control a function thereof according to a moving direction and an angle of the control device 200, a time of directing one point toward the display apparatus 100, and the like.

According to an exemplary embodiment, if an input maintaining time of the voice explanation on/off key 422 exceeds the threshold time, the display apparatus 100 may display the shortcut menu window 610 of FIG. 6 on the screen. Alternatively, if an input maintaining time of touching a key displayed on the touchpad 430 of the control device 200 exceeds the threshold time, the display apparatus 100 may display the shortcut menu window 610 of FIG. 6 on the screen. Alternatively, if a maintaining time of directing one point toward the display apparatus 100 exceeds the threshold time, the display apparatus 100 may display the shortcut menu window 610 of FIG. 6. That is, if for example the user holds the control device 200 in the example of FIG. 4B to point at the display apparatus for a threshold time or more, the display apparatus 100 may display the shortcut menu window 610 of FIG. 6. It should be noted that the alternative provided above may be provided in one control device 200, such that the user has various input options on one device to display the shortcut menu 610. A method of displaying the shortcut menu window 610 of FIG. 6 is not limited thereto. For example, the display apparatus 100 may display the shortcut menu window 610 of FIG. 6 on the screen according to a motion of moving the control device 200.

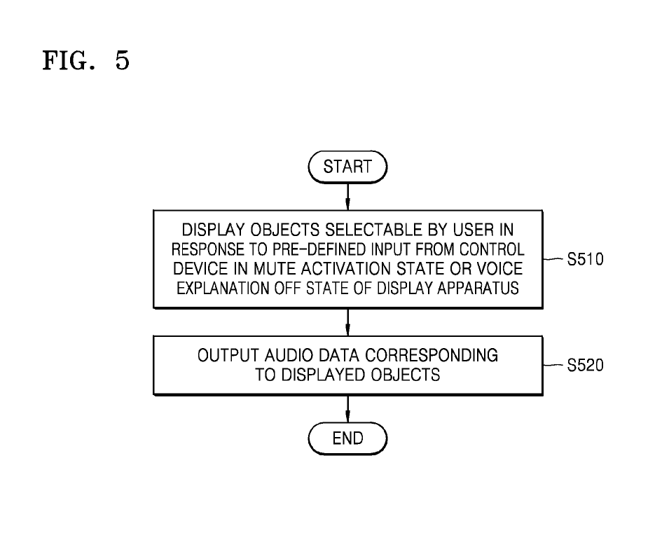

FIG. 5 illustrates a flowchart of a method of operating the display apparatus 100, according to an exemplary embodiment.

Referring to FIG. 5, in operation S510, the display apparatus 100 displays objects selectable by the user in response to a pre-defined input from the control device 200 in the mute activation state or the voice explanation off state of the display apparatus 100. Herein, the pre-defined input from the control device 200 may be a long-pressed input via a specific kay (e.g., the mute activation/inactivation key 412, the menu key 414, or the like) provided on the control device 200. In addition, the objects selectable by the user may include at least one of icons, texts, and images for executing the mute activation/inactivation function, the screen magnification function, the control device guide function, and the like. The objects may be preset and/or pre-defined.

According to an exemplary embodiment, the display apparatus 100 may display a shortcut menu window including objects on the screen, as shown in FIG. 6. Alternatively, the display apparatus 100 may independently display each of the objects in one region on the screen.

In operation S520, the display apparatus 100 outputs audio data corresponding to the objects displayed on the screen. Herein, the audio data corresponding to the objects may include voice information for explaining that a shortcut menu window has been displayed, when the display apparatus 100 displays the shortcut menu window including the objects on the screen. In addition, the audio data corresponding to the objects may include voice information of at least one of a name of a function corresponding to each of the objects and a feature or status of the function.

If the mute function of the display apparatus 100 is activated, the display apparatus 100 does not normally output audio data and a voice explanation of image content being played. In this case, a user having a visual handicap cannot know whether the mute function of the display apparatus 100 is activated and may misunderstand that the display apparatus 100 is in a power off state. In another case, if the display apparatus 100 is in the voice explanation off state, the display apparatus 100 does not normally output a voice explanation. In this case, the user having a visual handicap may also suffer difficulty to operate the display apparatus 100.

Therefore, according to an exemplary embodiment, if a pre-defined input from the control device 200 is received, the display apparatus 100 may output audio data corresponding to the objects that would otherwise normally be displayed on the screen even in the mute activation state or the voice explanation off state. The user of the display apparatus 100 may inactivate the mute function and turn on the voice explanation function based on the outputted audio data. As such, according to an exemplary embodiment, the display apparatus 100 may provide a method by which a user having a visual handicap easily uses the display apparatus 100.

Although it has been described that the display apparatus 100 is in the mute activation state or the voice explanation off state, the exemplary embodiments described above are not limited thereto. If a pre-defined input from the control device 200 is received in a mute inactivation state or the voice explanation on state, the display apparatus 100 may output both audio data of content being played and audio data corresponding to objects displayed on the screen.

FIG. 6 illustrates an example in which the display apparatus 100 displays objects selectable by a user on the screen.

Referring to FIG. 6, if a pre-defined input from the control device 200 is received, the display apparatus 100 may display the shortcut menu window 610 including first, second, and third objects 612, 614, and 616 on the screen. The first, second, and third objects 612, 614, and 616 may be preset. In this case, the display apparatus 100 may guide through a voice that the shortcut menu window 610 has been displayed on the screen, in response to the pre-defined input from the control device 200. For example, the display apparatus 100 may output audio data “shortcut menu window is activated” through a speaker 620 provided on the display apparatus 100.

According to an exemplary embodiment, the display apparatus 100 may output audio data for informing that the shortcut menu window 610 has been displayed, even in a mute activation state 650. In this case, the display apparatus 100 may not output audio data of image content being played to the outside.

According to another exemplary embodiment, the display apparatus 100 may output the audio data for informing that the shortcut menu window 610 has been displayed, even in the voice explanation off state. In this case, the display apparatus 100 may not output audio data for an input (e.g., a broadcast channel up/down input, a broadcast volume up/down input, or the like) other than an input of controlling the shortcut menu window 610.

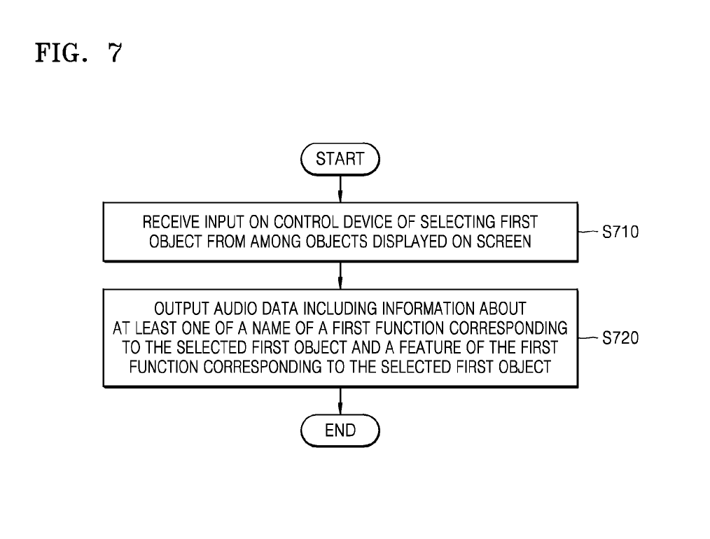

FIG. 7 illustrates a flowchart of a method by which the display apparatus 100 outputs audio data corresponding to objects displayed on the screen, according to an exemplary embodiment.

In operation S710, the display apparatus 100 receives an input via the control device 200 of selecting a first object from among the objects displayed on the screen. For example, the display apparatus 100 may select the first object from among the objects displayed on the screen by using a direction key, a touchpad, or a pointing function of the control device 200.

The display apparatus 100 may change a color and/or a size of a text or image of the first object from a previous color and/or size to indicate that the first object has been selected. Alternatively or additionally, the display apparatus 100 may vibrate and/or focus the first object to indicate that the first object has been selected.

In operation S720, the display apparatus 100 outputs audio data including information about at least one of a name of a first function corresponding to the selected first object and a feature of the first function corresponding to the selected first object. The feature of the first function may include a status of the first function. Alternatively, the display apparatus 100 may output audio data including voice information for explaining that first function has been selected.

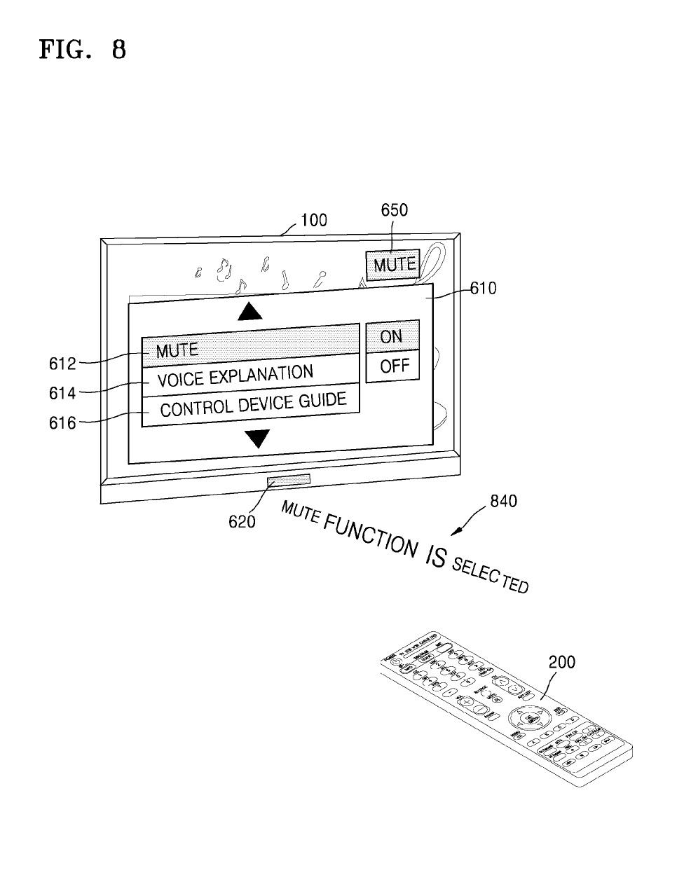

FIG. 8 illustrates an example in which the display apparatus 100 outputs audio data corresponding to the selected first object.

Referring to FIG. 8, the display apparatus 100 may select the first object 612 from among the first, second, and third objects 612, 614, and 616 included in the shortcut menu window 610, based on an input from the control device 200. The first object 612 may correspond to, for example, the mute function. In this case, the display apparatus 100 may change a color of the first object 612 to be different from colors of the other objects 614 and 616 to indicate that the first object 612 has been selected.

In addition, the display apparatus 100 may output voice information for explaining that the first object 612 has been selected. For example, the display apparatus 100 may output audio data 840 “mute function has been selected” through the speaker 620. In this case, the mute function of the display apparatus 100 may be in an active state. Alternatively or additionally, the voice explanation function of the display apparatus 100 may be in an off state when the output audio data 840 is output.

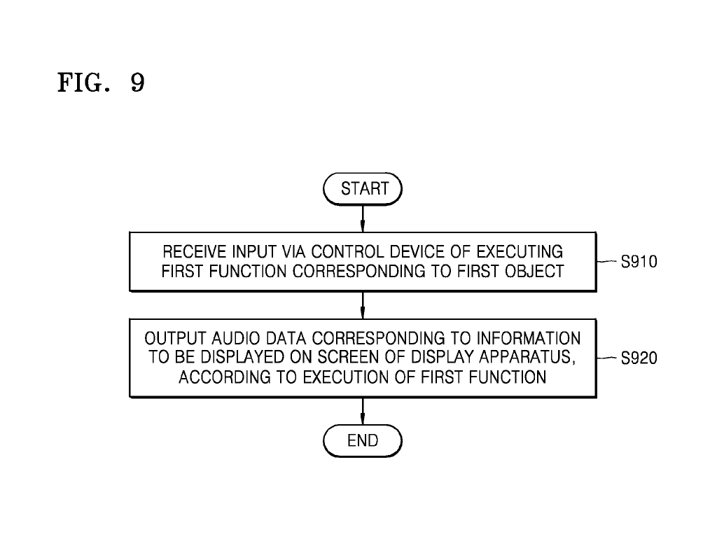

FIG. 9 illustrates a flowchart of a method by which the display apparatus 100 outputs audio data according to the execution of the first function corresponding to the first object, according to an exemplary embodiment.

Referring to FIG. 9, in operation S910, the display apparatus 100 receives an input via the control device 200 of executing the first function corresponding to the first object. For example, the display apparatus 100 may execute the first function corresponding to the first object by using an enter key, a menu key, or an option key of the control device 200.

In operation S920, the display apparatus 100 outputs audio data corresponding to information to be displayed on the screen of the display apparatus 100, according to the execution of the first function. For example, if an environment configuration of the display apparatus 100 is changed (e.g., the mute function is activated/inactivated, the voice explanation function is turned on/off, or the like) according to the execution of the first function, the display apparatus 100 may output audio data including voice information for explaining that the environment configuration has been changed. If the screen is switched (e.g., the control device guide function is executed, or the like) according to the execution of the first function, the display apparatus 100 may output audio data including voice information of explaining that the screen has been switched.

FIG. 10 illustrates a block diagram of the display apparatus 100 according to another exemplary embodiment. Referring to FIG. 10, the display apparatus 100 may include a display 1010, an audio output module 1020, a user input module 1030, and a controller 1040.

According to an exemplary embodiment, the display 1010 may correspond to the display 110 of FIG. 2. The display 1010 may output an image received from the outside or an image stored in the display apparatus 100, under control of the controller 1040. In addition, the display 1010 may display various graphic user interface (GUI) on a screen.

According to an exemplary embodiment, the audio output module 1020 may correspond to the audio output module 120 of FIG. 2.

According to an exemplary embodiment, the user input module 1030 may be configured to input data for controlling the display apparatus 100. For example, the user input module 1030 may acquire control data for controlling the display apparatus 100 from an input from the control device 200, a voice of a user, an image of the user, or the like.

For example, the user input module 1030 may receive an optical signal (including a control signal) received from the control device 200, through an optical window (not shown) of a bezel of the display 1010. The user input module 1030 may receive an optical signal corresponding to a user input (e.g., a touch, a press, a touch gesture, a voice, or a motion) from the control device 200.

Control data may be extracted from the received optical signal under control of the controller 1040. For example, the extracted control data may be a hexadecimal code.

Alternatively, the user input module 1030 may receive an uttered voice of the user. Alternatively, the user input module 1030 may receive an image corresponding to a motion of the user. Control data may be extracted from the received voice or image under control of the controller 1040.

According to an exemplary embodiment, the controller 1040 controls a general operation of the display apparatus 100 and a signal flow between the internal components of the display apparatus 100 and executes a function of processing data.

According to an exemplary embodiment, the controller 1040 may execute the control device guide function. In this case, the control device guide function is to allow the user to learn keys provided on the control device 200 (including physical buttons or touch buttons displayed on a touchpad).

According to an exemplary embodiment, the controller 1040 may provide the control device guide function in the middle of an operation of the display apparatus 100. For example, the controller 1040 may provide the control device guide function on an initial configuration screen image (i.e., power is initially applied to the display apparatus 100).

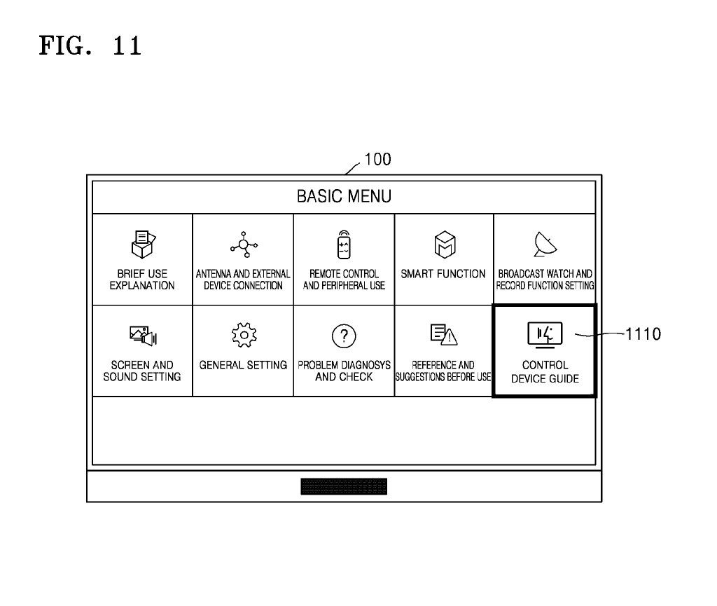

Alternatively, the controller 1040 may provide the control device guide function as one sub-menu 1110 of an environment configuration menu provided by the display apparatus 100, as shown in FIG. 11.

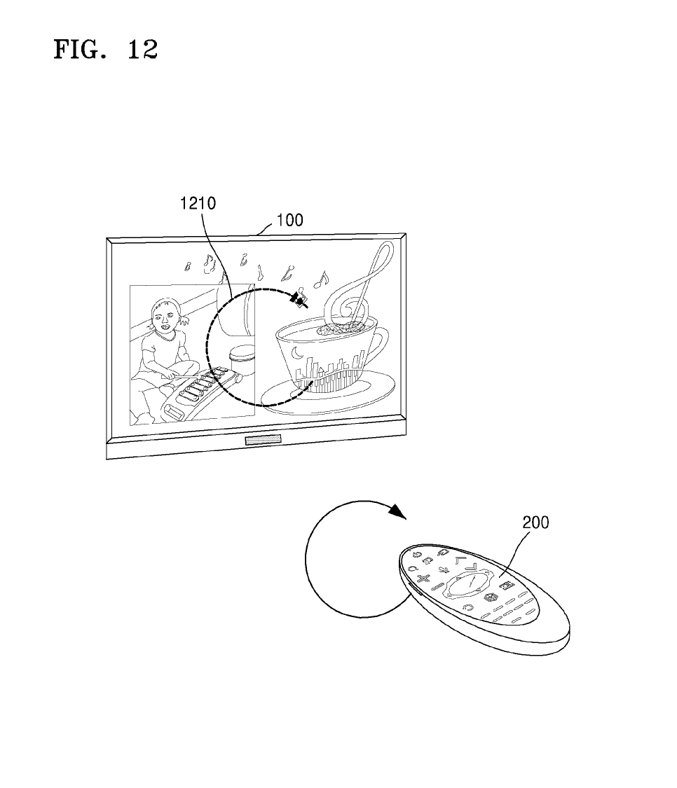

Alternatively, if the control device 200 is implemented by the pointing device of FIG. 4B, the controller 1040 may provide the control device guide function when the user input module 1030 receives a specific motion input 1210 due to a moving direction, an angle, or the like of the control device 200, as shown in FIG. 12.

Alternatively, if a pre-defined input from the control device 200 is received as shown in FIG. 2 or FIG. 6, the controller 1040 may display, on the screen, the selectable object 616 (see FIG. 6) through which the control device guide function is executable.

Alternatively, if an input via a specific key provided on the control device 200 is received through the user input module 1030, the controller 1040 may immediately execute the control device guide function. A method of executing the control device guide function is not limited thereto.

According to an exemplary embodiment, if control data is received from the user input module 1030, the controller 1040 may determine whether the control device guide function is activated.

If the control device guide function is inactivated, the controller 1040 may perform an operation corresponding to the control data, such as a channel change, channel up/down, volume up/down, a menu execution, or the like, by using a key mapping table. In this case, the key mapping table may define an operation to be performed by the display apparatus 100 with respect to each control data.

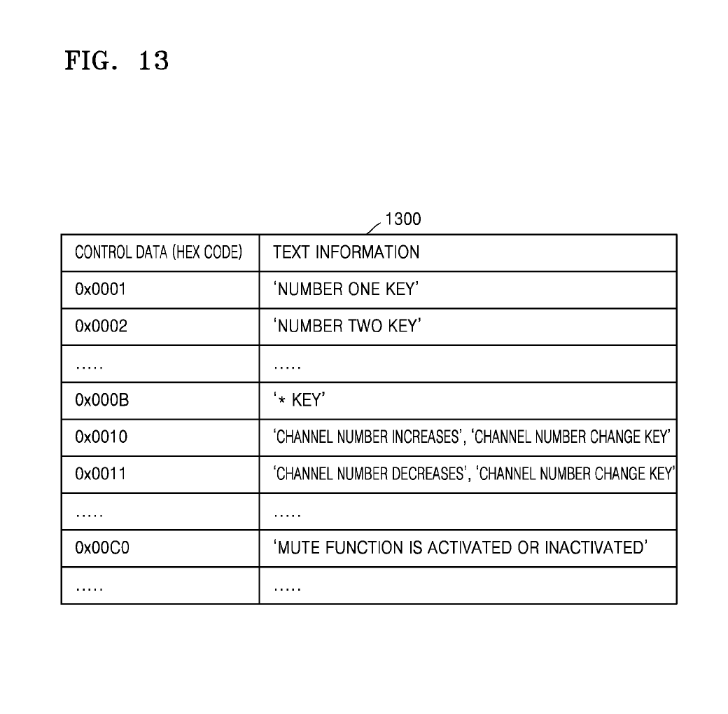

If the control device guide function is activated, the controller 1040 may control the audio output module 1020 to output audio data corresponding to the control data by using a key explanation table (refer to FIG. 13). In this case, the controller 1040 may not perform an operation corresponding to the control data (i.e., an operation defined in the key mapping table). That is, for example if the control device guide function is activated, when a user presses the key marked or assigned “1”, the controller 1040 may control the audio output module 1020 to output audio data “Number One Key” such that a visually impaired user may know that the key that the user pressed is the key marked or assigned “1”.

FIG. 13 illustrates an example of the key explanation table.

Referring to FIG. 13, a key explanation table 1300 includes text data of keys corresponding to control data (hex code) received from the user input module 1030. The control data may correspond to each of keys provided on the control device 200. In addition, each text data may include information about at least one of a name of each of the keys provided on the control device 200 and a function corresponding to each of the keys.

According to an exemplary embodiment, if control data is received from the user input module 1030, the controller 1040 may acquire text data corresponding to the control data from the key explanation table 1100. The controller 1040 may convert the acquired text data into audio data and transmit the converted audio data to the audio output module 1020. For example, the controller 1040 may convert the acquired text data into the audio data by using a text-to-speech engine.

Referring back to FIG. 10, if the control device guide function is activated, the controller 1040 may control the display 1010 to display image data corresponding to control data on the screen. The image data may be a magnified image of the external appearance of a key corresponding to the control data in the external appearance of the control device 200.

The controller 1040 may store data including information about the external appearance of the control device 200 in the display apparatus 100 or acquire the data from an external server or the control device 200.

If an input via a new control device 200 is received, the controller 1040 may acquire information about the external appearance of the new control device 200 from the external server or the control device 200. In addition, if the input via the new control device 200 is received, the controller 1040 may update the key explanation table.

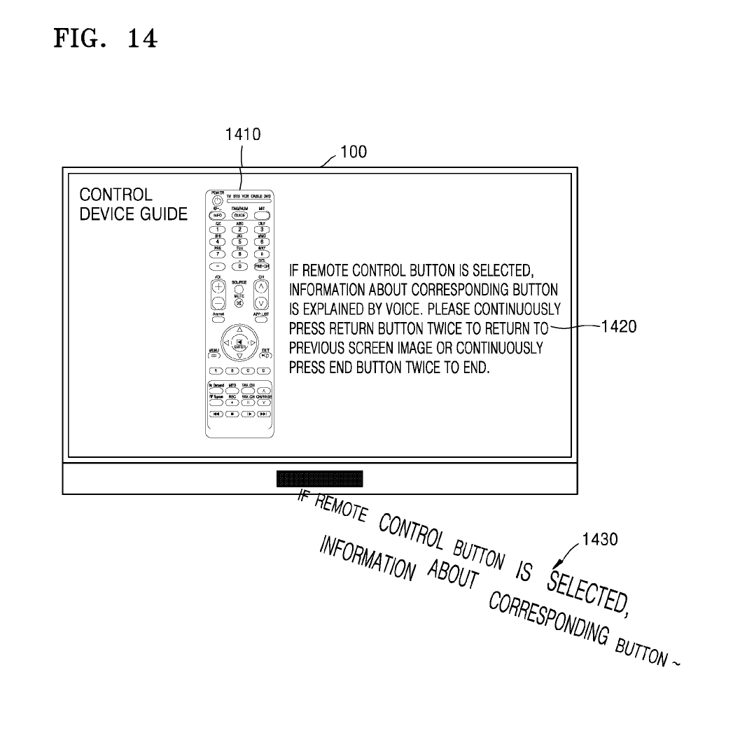

FIG. 14 illustrates an example in which the display apparatus 100 displays, on the screen, the fact that the control device guide function is activated.

As shown in FIG. 14, the controller 1040 of FIG. 10 may display, on the screen, the fact that the control device guide function is activated if the control device guide function is activated. For example, the controller 1040 may control the display 1010 of FIG. 10 to display, on the screen, image data 1410 indicating the external appearance of the control device 200 and text data 1420 including a method of executing the control device guide function.

In addition, if the control device guide function is activated, the controller 1040 may output, through the audio output module 1020, audio data 1430 for explaining the method of executing the control device guide function, even in the mute activation state and/or the voice explanation off state.

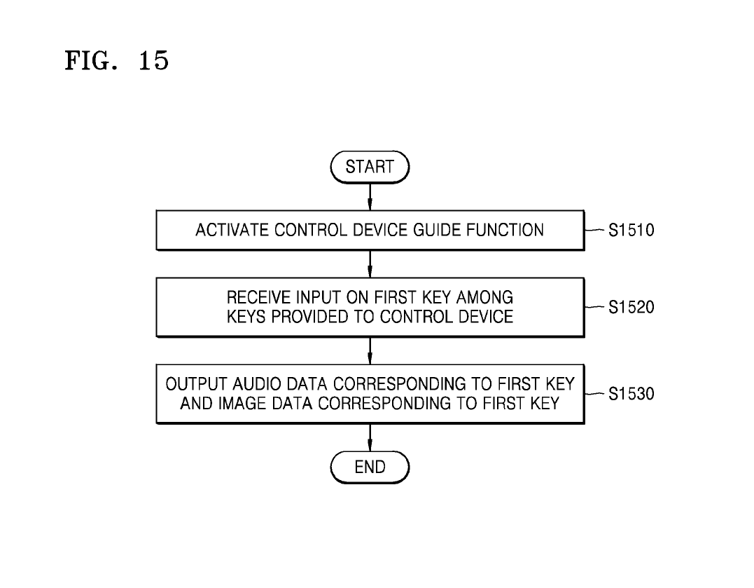

FIG. 15 illustrates a flowchart of a method of operating the display apparatus 100, according to another exemplary embodiment.

Referring to FIG. 15, in operation S1510, the display apparatus 100 activates the control device guide function.

According to an exemplary embodiment, the display apparatus 100 may provide the control device guide function on an initial configuration screen image (i.e., power is initially applied to the display apparatus 100) of the display apparatus 100. Alternatively, the display apparatus 100 may provide the control device guide function as one sub-menu 1110 of the environment configuration menu provided by the display apparatus 100, as shown in FIG. 11. Alternatively, if a pre-defined input from the control device 200 is received as shown in FIG. 2 or FIG. 6, the display apparatus 100 may display, on the screen, the selectable object 616 through which the control device guide function is executable. Alternatively, if an input via a specific key provided on the control device 200 (e.g., the CC key 418 provided on the control device 200 of FIG. 4A) is received through the user input module 1030, the display apparatus 100 may immediately the control device guide function.

In operation S1520, the display apparatus 100 receives an input via a first key among the keys provided on the control device 200. The display apparatus 100 may receive an optical signal corresponding to the first key from the control device 200. In addition, the display apparatus 100 may extract control data from the received optical signal.

In operation S1530, the display apparatus 100 outputs audio data corresponding to the first key and image data corresponding to the first key.

According to an exemplary embodiment, the display apparatus 100 may acquire text data mapped to control data corresponding to the first key by using the key explanation table 1300 of FIG. 13. In addition, the display apparatus 100 may convert the acquired text data into audio data.

In addition, the display apparatus 100 may display, on the screen, image data obtained by magnifying a portion of the external appearance of the control device 200. For example, the display apparatus 100 may display, on the screen, image data obtained by magnifying a portion corresponding to the first key from the external appearance of the control device 200.

The keys provided on the control device 200 may be physical buttons, or may be touch buttons appearing on the touchpad 430 if the control device includes the touchpad 430 as shown in FIG. 4B. In addition, if the control device 200 is implemented by the pointing device as shown in FIG. 4B, the display apparatus 100 may receive a motion input according to a moving direction, an angle, or the like of the control device 200 and output audio data and image data corresponding to the motion input.

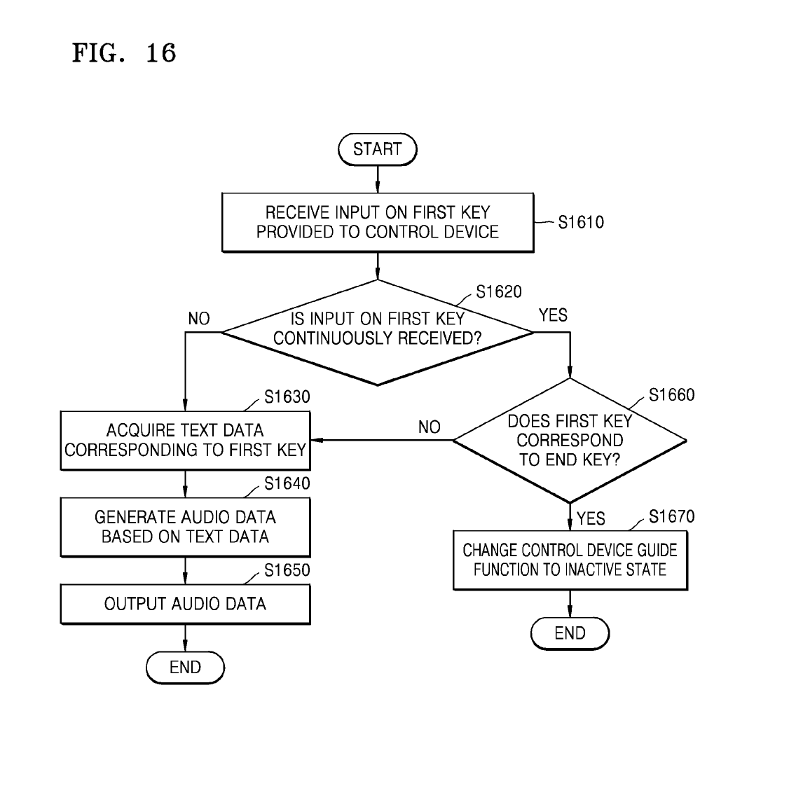

FIG. 16 illustrates a flowchart of a method by which the display apparatus 100 executes the control device guide function, according to another exemplary embodiment.

Referring to FIG. 16, in operation 51610, the display apparatus 100 receives an input via a first key provided on the control device 200.

In operation S1620, the display apparatus 100 determines whether the input via the first key is continuously received. To this end, the display apparatus 100 may store an input history from the control device 200. The display apparatus 100 may determine whether the input via the first key is continuously received, by using the stored input history.

If the input via the first key is not continuously received (S1620, NO), the display apparatus 100 acquires text data corresponding to the first key in operation S1630. The display apparatus 100 may acquire the text data corresponding to the first key by using the key explanation table 1300 of FIG. 13. In operation S1640, the display apparatus 100 generates audio data based on the text data. For example, the display apparatus 100 may convert the text data into the audio data by using a text-to-speech engine. In operation S1650, the display apparatus 100 outputs the audio data. In addition, the display apparatus 100 may output image data obtained by magnifying the external appearance corresponding to the first key in the external appearance of the control device 200.

If the input via the first key is continuously received (S1620, YES), the display apparatus 100 determines whether the first key is an end key in operation S1660. The end key may be any one of a return key (484 of FIG. 4A or 490 of FIG. 4B), an exit key (484 of FIG. 4A), and an option key (416 of FIG. 4A) provided on the control device 200 but is not limited thereto. If the first key is the end key (S1660, YES), the display apparatus 100 performs an operation corresponding to the first key by using a key mapping table instead of the key explanation table (1300 of FIG. 13). Accordingly, the display apparatus 100 may change the control device guide function to an inactive state in operation S1670.

If the first key is not the end key (S1660, NO), the display apparatus 100 performs operations S1630 to S1650.

For example, if an input of pressing a key “1” of the control device 200 by the user is received, the display apparatus 100 may determine in operation S1620 whether the key “1” is continuously pressed. If the key “1” is continuously pressed (e.g., if the user continuously presses the key “1” twice), the display apparatus 100 may determine in operation S1660 whether the key “1” is the end key. If the key “1” is not the end key, the display apparatus 100 may output audio data (e.g., “number one key”) corresponding to the key “1” by performing operations S1630 to S1650. If the key “1” is the end key, the display apparatus 100 may change the control device guide function to an inactive state in operation S1670.

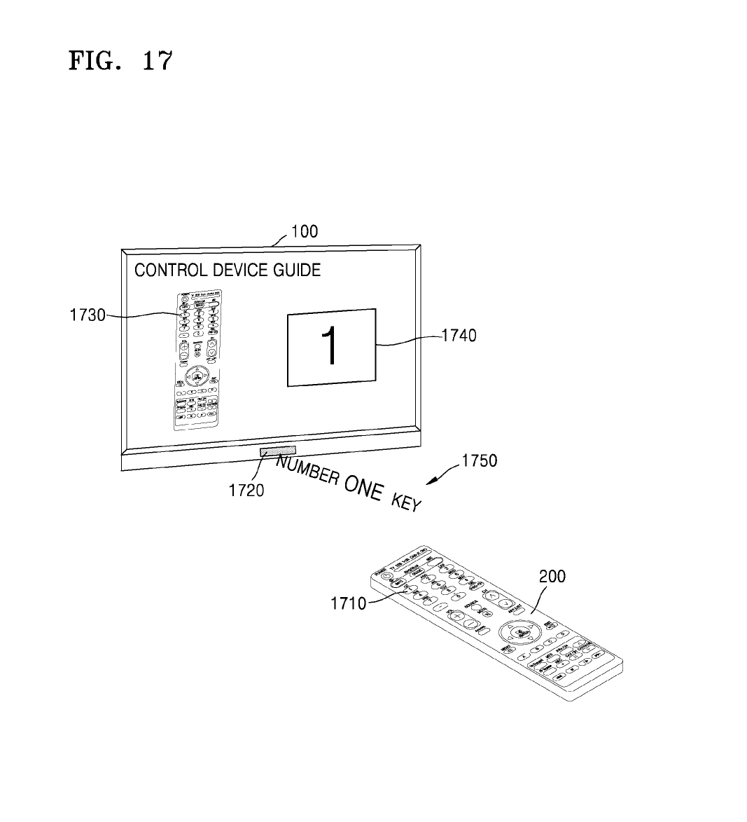

FIG. 17 illustrates an example in which the display apparatus 100 outputs audio data and image data in response to an input from the control device 200.

Referring to FIG. 17, the display apparatus 100 may receive an input 1710 of pressing the key “1” from the control device 200. The display apparatus 100 may output audio data 1750 (e.g., “number one key”) of explaining a name of the key “1” by using the key explanation table (1300 of FIG. 13), through a speaker 1720 provided on a side surface of the display apparatus 100.

In addition, the display apparatus 100 may display, on the screen, image data 1730 of the external appearance of the control device 200 and magnified image data 1740 of the external appearance corresponding to the key “1” in the external appearance of the control device 200.

As such, if a user having a visual handicap presses one key provided on the control device 200, by outputting a description corresponding to the pressed key and magnifying and displaying the external appearance of the control device 200, the display apparatus 100 may induce the user to learn the control device 200.

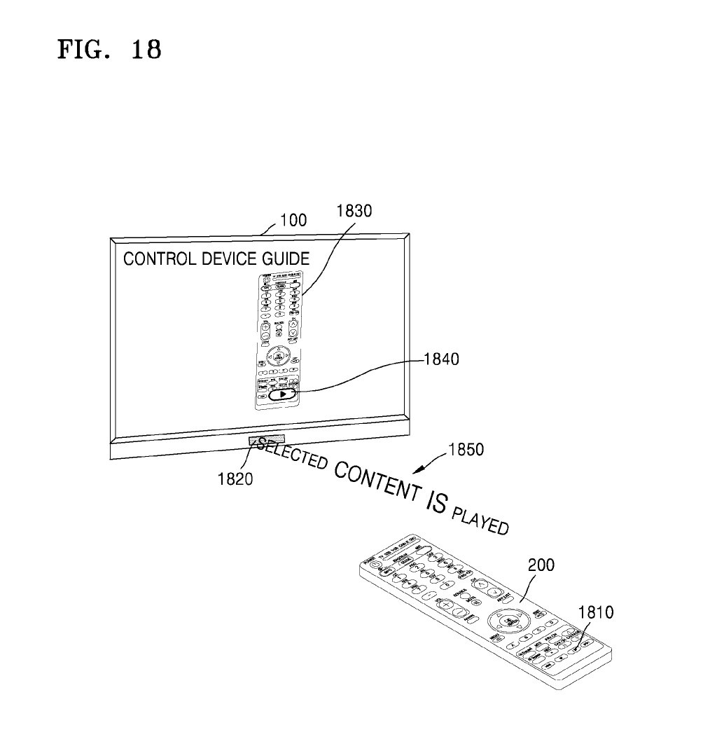

FIG. 18 illustrates another example in which the display apparatus 100 outputs audio data and image data in response to an input from the control device 200.

Referring to FIG. 18, the display apparatus 100 may receive an input 1810 on a key “ [symbol] ” from the control device 200. The display apparatus 100 may output audio data 1850 (e.g., “selected content is played”) of explaining a feature corresponding to the key “ [symbol] ” by using the key explanation table (1300 of FIG. 13).

In addition, the display apparatus 100 may display, on the screen, image data 1830 of the external appearance of the control device 200 and magnified image data 1840 of the external appearance corresponding to the key “ [symbol] ” in the external appearance of the control device 200 in an overlapping manner.

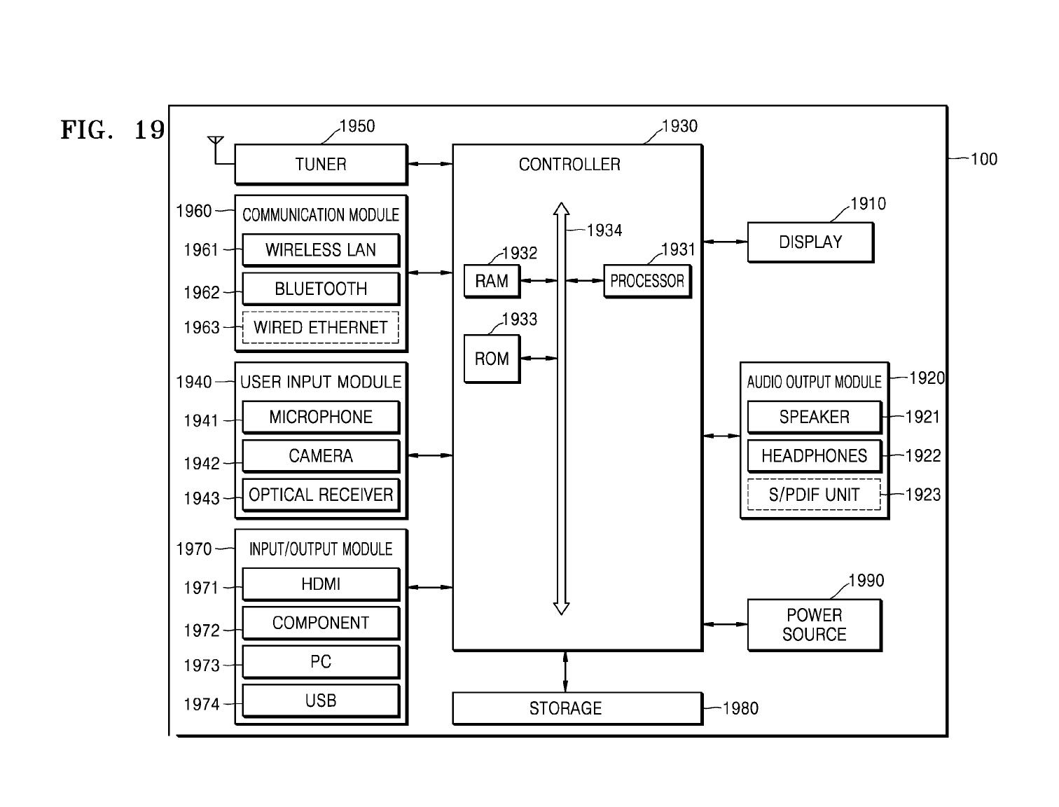

FIG. 19 illustrates a detailed block diagram of the display apparatus 100.

Referring to FIG. 19, the display apparatus 100 may further include a tuner 1950, a communication module 1960, an input/output module 1970, a storage 1980, and a power source 1990 besides a display 1910, an audio output module 1920, a controller 1930, and a user input module 1940 respectively corresponding to the displays 110 and 1010, the audio output modules 120 and 1020, the controller 130 and 1040, and the user input module 1030 of FIG. 2 or FIG. 10.

In addition, the display apparatus 100 having the display 1910 may be electrically connected to a separate external device (e.g., a set-top box (not shown)). For example, it will be readily understood by those of ordinary skill in the art that the display apparatus 100 may be implemented by an analog TV, a digital TV, a 3D TV, a smart TV, an LED TV, an OLED TV, a plasma TV, a monitor, or the like but is not limited thereto.

The display 1910 may display a video included in a broadcast signal received through the tuner 1950, under control of the controller 1930. In addition, the display 1910 may display content (e.g., a video) inputted through the communication module 1960 or the input/output module 1970. The display 1910 may display an image stored in the storage 1980, under control of the controller 1930.

According to an exemplary embodiment, the display 1910 may correspond to the display 110 of FIG. 2 or the display 1010 of FIG. 10.

According to an exemplary embodiment, the display 1910 may display objects selectable by a user under control of the controller 1930. In this case, the objects selectable by the user may include at least one of icons, texts, and images through which at least one of the mute inactivation function, the screen magnification function, and the control device guide function is executable. For example, the display 1910 may display a shortcut menu window including the objects.

According to an exemplary embodiment, the display 1910 may output image data corresponding to a key input from the control device 200 in response to the key input under control of the controller 1930.

The audio output module 1920 may output audio data processed by the display apparatus 100. The audio output module 1920 may include at least one of a speaker 1921, a headphone output terminal 1922, and a Sony/Philips digital interface (S/PDIF) output terminal 1923.

According to an exemplary embodiment, the audio output module 1920 may correspond to the audio output module 120 of FIG. 2 or the audio output module 1020 of FIG. 10.

According to an exemplary embodiment, the audio output module 1920 may output audio data corresponding to the objects displayed on the display 1910, under control of the controller 1930.

According to an exemplary embodiment, the audio output module 1920 may output audio data corresponding to a key input from the control device 200 in response to the key input under control of the controller 1930.

The controller 1930 may include a processor 1931, a read only memory (ROM) 1932 in which a control program for controlling the display apparatus 100 is stored, and a random access memory (RAM) 1932 to be used to store a signal or data inputted from the outside of the display apparatus 100 or used as a storage region corresponding to various tasks to be performed by the display apparatus 100. The processor 1931 may include at least one microprocessor.

The controller 1930 controls a general operation of the display apparatus 100 and a signal flow between the internal components of the display apparatus 100 and executes a function of processing data, as described above. The controller 1930 controls power to be supplied from the power source 1990 to the internal components 1910 to 1980. In addition, the controller 1930 may execute an operating system (OS) and various applications stored in the storage 1980.

The processor 1931 may include a graphic processor (GPU) (not shown) for graphic processing corresponding to a video or an image. The processor 1931 may be implemented by a system on chip (SoC) in which a core (not shown) and the GPU are integrated. The processor 1931 may include a single core, dual cores, triple cores, quadruple cores, or cores of a multiple thereof.

In addition, the processor 1931 may include a plurality of processors. For example, the processor 1931 may be implemented by a main processor (not shown), and a sub-processor (not shown) operating in a sleep mode. In addition, the processor 1931, the ROM 1933, and the RAM 1932 may be mutually connected through a bus 1934.

In the exemplary embodiments described above, the term “controller” of the display apparatus 100 may include the processor 1931, the ROM 1933, and the RAM 1932.

According to an exemplary embodiment, the controller 1930 may correspond to the controller 130 of FIG. 2 or the controller 1040 of FIG. 10.

According to an exemplary embodiment, the controller 1930 may control the display 1910 to display the objects selectable by the user on the screen of the display apparatus 100 in response to a pre-defined input from the control device 200 in the mute activation state or the voice explanation off state. In addition, the controller 1930 may control the audio output module 1920 to output audio data corresponding to the objects displayed on the screen of the display apparatus 100. In this case, the pre-defined input from the control device 200 may include a long-pressed input via a specific kay (e.g., the mute activation/inactivation key 412, the menu key 414, the CC key 418, the AD key (not shown), or the like of FIG. 4A) provided on the control device 200. Alternatively, the pre-defined input from the control device 200 may include a continuous input via a specific key provided on the control device 200 within a short time. For example, when a specific key provided on the control device 200 is pressed twice within one second, the controller 1930 may define this case as the pre-defined input.

According to an exemplary embodiment, the controller 1930 may control the audio output module 1920 to output audio data including information about at least one of a name of a first function corresponding to a first object and a feature of the first function corresponding to the first object in response to an input via the control device 200 of selecting the first object from among the objects displayed on the screen of the display apparatus 100.

According to an exemplary embodiment, the controller 1930 may control the display 1910 to display audio data and image data corresponding to a first key in response to a first key input from the control device 200 in a state where the control device guide function is activated.

The tuner 1950 may select a channel to be desired to receive in the display apparatus 100 by tuning only a frequency of the channel from among many electronic wave components through amplification, mixing, resonance of a broadcast signal received in a wired or wireless manner. The broadcast signal may include audio, video, and additional information (e.g., EPG).

The tuner 1950 may receive the broadcast signal in a frequency band corresponding to a channel number (e.g., a cable broadcast channel number 506) according to an input (e.g., a channel number input, a channel up/down input, or the like) from the control device 200.

The tuner 1950 may receive the broadcast signal from various sources such as terrestrial broadcasting stations, cable broadcasting stations, satellite broadcasting stations, Internet broadcasting stations, and the like.

The tuner 1950 may receive the broadcast signal from sources such as analog broadcasting stations, digital broadcasting stations, and the like. The broadcast signal received through the tuner 1950 is decoded (e.g., audio decoding, video decoding, or additional information decoding) and separated into audio, video, and/or additional information. The separated audio, video, and/or additional information may be stored in the storage 1980 under control of the controller 1930.

The tuner 1950 of the display apparatus 100 may be single or plural in number. The tuner 1950 may be implemented to be all-in-one with the display apparatus 100 or as a separate device (e.g., a set-top box (not shown), a tuner (not shown) connected to the input/output module 1970) having a tuner electrically connected to the display apparatus 100.

The communication module 1960 may connect the display apparatus 100 with an external device (e.g., an audio device or the like) under control of the controller 1930. The controller 1930 may transmit/receive content to/from the external device connected through the communication module 1960, download an application from the external device, or perform web browsing through the communication module 1960. The communication module 1960 may include at least one of a wireless LAN module 1961, a Bluetooth module 1962, and a wired Ethernet module 1963 in correspondence with the performance and structure of the display apparatus 100. In addition, the communication module 1960 may further include short-distance communication modules (e.g., an NFC module (not shown) and a BLE module (not shown)) other than the Bluetooth module 1962.

The user input module 1940 may receive an input from the control device 200, a voice of the user, an image of the user, and the like. The user input module 1940 may include an optical receiver 1941, a microphone 1942, and/or a camera 1943.

The optical receiver 1941 may receive an optical signal (including a control signal) received from the control device 200, through an optical window (not shown) or the like of a bezel of the display 1910. The optical receiver 1941 may receive an optical signal corresponding to a user input (e.g., a touch, a press, a touch gesture, a voice, or a motion) from the control device 200. Control data may be extracted from the received optical signal under control of the controller 1930. It will be readily understood by those of ordinary skill in the art that the control signal received from the control device 200 may be implemented in a Bluetooth type, a radio frequency (RF) signal type, or a Wi-Fi type instead of an optical signal type.

The microphone 1942 may receive an uttered voice of the user. The microphone 1942 may convert the received voice into an electrical signal and transmit the converted electrical signal to the controller 1930. The voice of the user may include, for example, a voice corresponding to a menu or function of the display apparatus 100. A recognition range of the microphone 1942 may be within about 4 m from the microphone 1942 to a location of the user and may vary depending on a magnitude of the voice of the user and a surrounding environment (e.g., a speaker sound and surrounding noise).

The microphone 1942 may be implemented to be all-in-one with or to be separated from the display apparatus 100. The separated microphone 1942 may be electrically connected to the display apparatus 100 through the communication module 1960 or the input/output module 1970. The microphone 1942 may include a plurality of microphones to implement a stereo and/or noise reduction input.

According to an exemplary embodiment, the user input module 1940 may receive a long-pressed input via a specific key from the control device 200.

According to an exemplary embodiment, the user input module 1940 may receive an input of activating the control device guide function. For example, the user input module 1940 may receive a motion input. The motion input may be preset.

According to an exemplary embodiment, the user input module 1940 may receive an input via a specific key from the control device 200. For example, the user input module 1940 may receive an input via an end key from the control device 200.

It will be readily understood by those of ordinary skill in the art that the microphone 1942 may be omitted according to the performance and structure of the display apparatus 100.

The input/output module 1970 receives a video (e.g., a moving picture or the like), audio (e.g., a voice, music, or the like), and additional information (e.g., EPG or the like) from the outside of the display apparatus 100, under control of the controller 1930. The input/output module 1970 may include at least one of a high-definition multimedia interface (HDMI) port 1971, a component jack 1972, a PC port 1973, and a universal serial bus (USB) port 1974.

It will be readily understood by those of ordinary skill in the art that a configuration and operation of the input/output module 1970 may be variously implemented according to embodiments of the inventive concept.

The storage 1980 may store various pieces of data, programs, and/or applications for driving and controlling the display apparatus 100, under control of the controller 1930. The storage 1980 may store input/output signals or data corresponding to driving of the display 1910, the audio output module 1920, the controller 1930, the user input module 1940, the tuner 1950, the communication module 1960, and the input/output module 1970. The storage 1980 may store control programs for controlling the display apparatus 100 and the controller 1930, applications initially provided by a manufacturer and downloaded from the outside, GUIs related to the applications, objects (e.g., image texts, icons, buttons, and the like) for providing the GUIs, user information, documents, databases (DB s), and/or relevant data.

According to an exemplary embodiment, the term “storage” may include the storage 1980, the ROM 1933 and the RAM 1932 in the controller 1930, and a memory card (e.g., a micro secure digital (SD) card, a USB memory, and the like) inserted into the display apparatus 100. In addition, the storage 1980 may include a nonvolatile memory, a volatile memory, and a hard disk drive (HDD) or a solid state drive (SDD).

Although not shown, the storage 1980 may include a broadcast reception module, a channel control module, a volume control module, a communication control module, a voice recognition module, a motion recognition module, an optical reception module, a display control module, an audio control module, an external input control module, a power control module, a module for controlling power of an external device connected in a wireless manner (e.g., Bluetooth), a voice DB, and/or a motion DB. The not-shown modules and DBs of the storage 1980 may be implemented in a software form to execute, in the display apparatus 100, a broadcast reception control function, a channel control function, a volume control function, a communication control function, a voice recognition function, a motion recognition function, an optical reception control function, a display control function, an audio control function, an external input control function, a power control function, and/or a function of controlling power of an external device connected in a wireless manner (e.g., Bluetooth). The controller 1930 may execute each of the functions by using the software stored in the storage 1980.

According to an exemplary embodiment, the storage 1980 may store a key mapping table, a key explanation table, and information about a key input history.

The power source 1990 may supply power inputted from an external power source to the internal components of the display apparatus 100, under control of the controller 1930. In addition, the power source 1990 may supply power outputted from one or more batteries (not shown) located inside the display apparatus 100 to the internal components of the display apparatus 100, under control of the controller 1930. At least one component may be added to or omitted from the components shown in FIG. 19 according to the performance of the display apparatus 100. In addition, it will be readily understood by those of ordinary skill in the art that locations of the components may be changed according to the performance or structure of the display apparatus 100.

The inventive concept can also be embodied by storing computer-readable codes in a non-transitory computer-readable storage medium. The non-transitory computer-readable storage medium is any data storage device that stores data which can be thereafter read by a computer system.

The computer-readable codes are configured to carry out operations implementing a display method of a display apparatus according to one or more exemplary embodiments when the computer-readable codes are read, from the computer-readable storage medium, and executed by a processor. The computer-readable codes may be embodied using various programming languages and the functional programs, codes and code segments for embodying the exemplary embodiments of the inventive concept may be easily programmed by those of ordinary skill in the art to which the inventive concept belongs.

Examples of the non-transitory computer-readable storage medium include ROM, RAM, CD-ROMs, magnetic tape, and optical data storage devices. The non-transitory computer-readable storage medium can also be distributed over a network coupled computer system so that the computer-readable codes are stored and executed in a distributed fashion.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A display apparatus comprising:
a display;
an audio output module; and
a controller configured to control the display to display objects selectable by a user on a screen of the display and control the audio output module to output audio data corresponding to the displayed objects, in response to an input from a control device, during a mute activation state or a voice explanation off state of the display apparatus.

2. The display apparatus of claim 1, wherein the input from the control device comprises a long-pressed input via a specific key provided on the control device.

3. The display apparatus of claim 1, wherein the objects include at least one of icons, texts, and images for executing at least one of a mute inactivation function, a screen magnification function, and a control device guide function.

4. The display apparatus of claim 1, wherein the controller controls the audio output module to output audio data including information about at least one of a name of a first function corresponding to a first object and a feature of the first function, in response to an input, received via the control device, of selecting the first object from among the displayed objects.

5. The display apparatus of claim 4, wherein the controller executes the first function corresponding to the first object in response to an input, received via the control device, of executing the first function corresponding to the first object, and controls the audio output module to output audio data corresponding to information to be displayed on the screen of the display apparatus according to the execution of the first function.

6. A display apparatus comprising:
a display;
an audio output module;
a user input module configured to receive an input of activating a control device guide function and to receive an input via a first key provided on the control device; and
a controller configured to control the audio output module and the display to respectively output audio data corresponding to the first key and image data corresponding to the first key, in response to the input via the first key.

7. The display apparatus of claim 6, wherein the controller controls the audio output module and the display not to perform an operation corresponding to the first key, according to the activation of the control device guide function.

8. The display apparatus of claim 6, wherein the audio data corresponding to the first key includes information about at least one of a name of the first key and a function corresponding to the first key.

9. The display apparatus of claim 6, wherein the image data corresponding to the first key is a magnified image of an external appearance of the first key in an external appearance of the control device.

10. The display apparatus of claim 6, wherein the input of activating the control device guide function is a preset motion input.

11. The display apparatus of claim 6, wherein the user input module receives an input via an end key provided on the control device, and
the controller inactivates the control device guide function when the input via the end key is continuously received.

12. A method of operating a display apparatus, the method comprising:
displaying objects selectable by a user on a screen of the display apparatus in response to an input from a control device, during a mute activation state or a voice explanation off state of the display apparatus; and
outputting audio data corresponding to the displayed objects.

13. The method of claim 12, wherein the input from the control device comprises a long-pressed input via a specific key provided on the control device.

14. The method of claim 12, wherein the objects include at least one of icons, texts, and images for executing at least one of a mute inactivation function, a screen magnification function, and a control device guide function.

15. The method of claim 12, wherein the outputting of the audio data corresponding to the displayed objects comprises:
receiving an input, via the control device, of selecting a first object from among the displayed objects; and
outputting audio data including information about at least one of a name of a first function corresponding to the first object and a feature of the first function, in response to the input via the control device.

16. The method of claim 15, wherein the outputting of the audio data corresponding to the displayed objects comprises:
receiving an input, via the control device, of executing the first function corresponding to the first object; and
outputting audio data corresponding to information to be displayed on the screen of the display apparatus according to the execution of the first function, in response to the input via the control device.

17. A method of operating a display apparatus, the method comprising:
activating a control device guide function;
receiving an input via a first key provided on a control device; and
outputting audio data corresponding to the first key and image data corresponding to the first key, in response to the input via the first key.

18. The method of claim 17, wherein the receiving of the input via the first key provided on the control device comprises not executing a function corresponding to the first key, according to the activation of the control device guide function.

19. The method of claim 17, wherein the audio data corresponding to the first key includes information about at least one of a name of the first key and a function corresponding to the first key.

20. The method of claim 17, wherein the image data corresponding to the first key is a magnified image of an external appearance of the first key in an external appearance of the control device.

21. The method of claim 17, wherein the input of activating the control device guide function is a preset motion input.

22. The method of claim 17, further comprising:
receiving an input via an end key provided on the control device; and
inactivating the control device guide function if the input via the end key is continuously received.

23. A non-transitory computer-readable medium having recorded thereon a computer-readable program for performing a method comprising:
displaying objects selectable by a user on a screen of the display apparatus in response to an input from a control device, during a mute activation state or a voice explanation off state of the display apparatus; and
outputting audio data corresponding to the displayed objects.

24. A display apparatus comprising:
an audio output module; and
a controller configured to, in response to receiving a pre-defined input from a control device, override a mute function or a voice explanation off function of the display apparatus and output, through the audio output module, audio data corresponding to objects normally displayed on the display apparatus.
